(19) United States
(12) Patent Application Publication
(10) Pub. No.: US 2010/0157058 A1
(43) Pub. Date: Jun. 24, 2010

(54) Method and Device for Compensating a Roll Angle

(75) Inventor: Dirk Feiden, Berlin (DE)

Correspondence Address: YOUNG BASILE, 3001 WEST BIG BEAVER ROAD, SUITE 624, TROY, MI, 48084, US

(73) Assignee: HELLA KGaA Hueck & Co., Lippstadt (DE)

(21) Appl. No.: 12/622,514

(22) Filed: Nov. 20, 2009

(30) Foreign Application Priority Data
Nov. 20, 2008 (DE) 10 2008 058 279.4

(51) Int. Cl. H04N 7/18; G06K 9/00

(52) U.S. Cl. 348/148; 382/106; 348/E07.085

(57) ABSTRACT

The invention relates to a method and a device for compensating a roll angle (α) when operating a camera-assisted driver assistance system in a motor vehicle. A camera takes a first image (32) and the coordinates of at least two characteristic points (30) of the first image (32) are determined. With the camera a second image (33) is taken and the coordinates of the two characteristic points (30) in the second image (33) are determined. Depending on the determined coordinates of the characteristic points (30) in the first and the second image (32, 33), two actual displacement vectors (IV_{—}1, IV_{—}3) are determined, each of which is representative for a displacement of the characteristic points (30) from the first image (32) to the second image (33) in an image plane of the camera. Depending on the determined coordinates of the characteristic points (30) of the first image (32) and depending on a speed of the motor vehicle two model displacement vectors (MV_N) are determined, each of which models the displacement of the characteristic points (30) from the first image (32) to the second image (33) in the image plane. Depending on the determined actual displacement vectors (IV_{—}1, IV_{—}3) and model displacement vectors (MV_N) a reference vector is determined. The roll angle (α) is then determined depending on the reference vector.

### FIELD OF THE INVENTION

The invention relates to a method and a device for compensating a roll angle when operating a camera-based driver assistance system in a motor vehicle.

### BACKGROUND

Modern driver assistance systems are routinely coupled to cameras and supported by way of image processing of the images taken by the cameras. For example, the cameras identify speed limits and/or lane markings. A lane-keeping assistant in particular analyzes the images taken by the camera for lane markings and warns the driver of the motor vehicle if he/she crosses the lane markings bordering the lane.

For a precise analysis of the images taken by the cameras it is advantageous for the driver assistance system and/or the image processing system to know the exact orientation of a camera with respect to the lane. In this context it is particularly advantageous when an image normal to a lower edge of the images taken is parallel to a surface normal to the lane. Alternatively, it is sufficient when an angle between the surface normal to the lane and the image normal is known so that this angle can be taken into account in the image analysis.

Given a planar lane, the angle between the surface normal of the lane and the image normal in the image plane of the camera can, for example, result from an improperly installed camera, a filling of the tank, a non-uniform loading of the motor vehicle and/or an uneven distribution of passengers in the motor vehicle.

When viewed in the direction of travel, this angle corresponds to a roll angle of the motor vehicle and is hereinafter referred to as roll angle in this context.

### SUMMARY OF THE INVENTION

It is the object of the present invention to specify a method and a device for compensating a roll angle when operating a camera-based driver assistance system, which easily and precisely allows for compensation of the roll angle.

This object is satisfied by the features of the independent claims. Advantageous embodiments are given in the subclaims.

The invention is distinguished by a method and a device for compensating a roll angle when operating a camera-based driver assistance system in a motor vehicle. With the aid of a camera on the motor vehicle, a first image is taken and the coordinates of at least two characteristic points of the first image are determined. Subsequently, with the aid of the camera a second image is taken and the coordinates of the two characteristic points in the second image are determined Depending on the determined coordinates of the characteristic points in the first and the second images, two displacement vectors are determined, each of which is representative of a displacement of the characteristic points in an image plane of the camera, in particular from the first image to the second image. Depending on the determined coordinates of the characteristic points of the first image and depending on a motion of the motor vehicle between the taking of the first image and the taking of the second image, two model displacement vectors are determined, each of which models the displacement of the characteristic points in the image plane. Depending on the determined actual displacement vectors and model displacement vectors, a reference vector is determined. Depending on the determined reference vector, the roll angle is determined.

This easily and precisely allows for a compensation of the roll angle, in particular given a low application expense and without additional sensor technology. The images can correspond to complete images taken by the camera or only parts thereof. Further, the images are preferably taken in the direction of travel of the motor vehicle. The motion of the motor vehicle between the taking of the first image and of the second image is preferably characterized by a speed of the motor vehicle.

In an advantageous embodiment, the reference vector is a model normal vector which is perpendicular to the lane and thus corresponds to a surface normal of the lane. Further, the roll angle is preferably determined by projecting the model normal vector onto the image plane and by comparing the projected model normal vector with an image normal in the image plane of the camera. The roll angle corresponds in this context to the angle between the projected model normal vector and the image normal.

In a further advantageous embodiment three or more actual displacement vectors and, accordingly, three or more model displacement vectors are determined, depending on which then the model normal vector is determined. As a result thereof, a mathematic system of equations for determining the model normal vector can be redefined, which can contribute to a particularly precise determination of the model normal vector.

In a further advantageous embodiment at least one of the actual displacement vectors is discarded and no longer taken into account, in particular the actual displacement vector whose angular deviation from the one or several averaged vectors is the largest. This can help to exclude incorrectly determined actual displacement vectors so they play no part in the determination of the model displacement vectors and of the model normal vector, and this contributes to the particularly precise determination of the model normal vector.

In a further advantageous embodiment, the model displacement vectors are dependent on the coordinates of the model normal vector. The model normal vector is determined in that by variation of the coordinates of the model normal vector a function value of a function is minimized, which function value corresponds to a difference between all actual displacement vectors taken into account and the corresponding model displacement vectors. This helps that the model normal vector is determined at a particularly low application expense. The difference between the actual displacement vectors and the corresponding model displacement vectors can, for example, be expressed by an amount of the differences of the associated vectors and subsequent summing up of all amounts. The model normal vector corresponds to the surface normal to the lane in an optimal way when the function value is minimal.

In a further advantageous embodiment, the determined roll angle is used for image correction of the camera image. Alternatively or additionally, the determined roll angle can automatically be made available to the driver assistance system. This contributes to a precise functioning of the driver assistance system and thus to the safety of the driver of the motor vehicle.

In a further advantageous embodiment, the model displacement vectors are determined by means of the general equation of motion, the imaging equation of a pinhole camera and the general equation of planes. This also contributes to the low application expense when programming the method. Embodiments of the invention are explained in more detail in the following with reference to schematic drawings.

### BRIEF SUMMARY OF THE DRAWINGS

The description herein makes reference to the accompanying drawings wherein like reference numerals refer to like parts throughout the several views and wherein:

FIG. 1 shows a view from a motor vehicle in the direction of travel with a first image;

FIG. 2 shows a second view from the motor vehicle in the direction of travel with a second image;

FIG. 3 shows a superposition of the first and the second image;

FIG. 4 shows formulas for calculating a model normal vector.;

FIG. 5 shows a schematic illustration of a roll angle correction; and

FIG. 6 shows an implementation of the invention in schematic form.

### DETAILED DESCRIPTION OF THE ILLUSTRATIVE EMBODIMENT

Elements having the same construction or function are identified with identical reference numbers and legends throughout all Figures.

FIG. 1 shows a road 20 with lane markings 24. The road 20 is visible up to a horizon 26. At the roadside, a traffic sign 28 can be seen. A camera, in particular a stereo camera or, alternatively, a pair of mono cameras, which is arranged in a motor vehicle, takes a first image 32 preferably in the direction of travel of the motor vehicle. Within the first image 32, by means of an image recognition system, characteristic points 30 are searched for. The image recognition system can, for example, have an edge finder which, on the basis of distinctive grey value transitions, searches for characteristic points 30 on the road 20. In this context, preferably characteristic points 30 are searched for which have a distance to one another that is as large as possible.

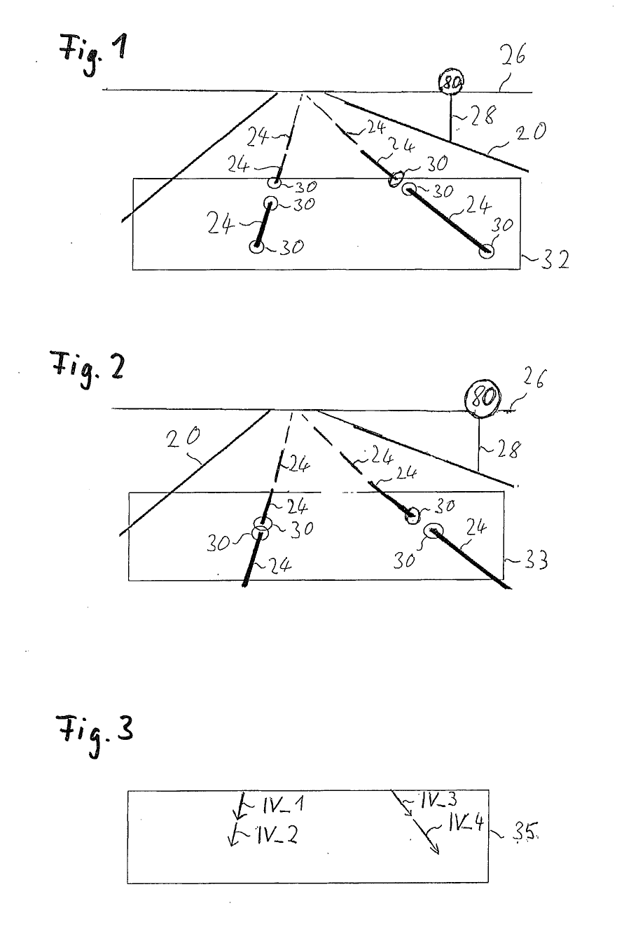

FIG. 2 shows a view onto the road 20 shortly after taking the first image 32. The camera takes a second image 33. The image recognition system again searches for the characteristic points 30 which now, however, as a result of an intermediate motion of the motor vehicle, are displaced in the second image 33 relative to the first image 32.

By means of an image comparison 35 shown in FIG. 3, an image analysis system can determine first to fourth actual displacement vectors IV_1 to IV_4 which are representative for the displacement of the characteristic points 30 in the image plane of the camera between the taking of the first image 32 and the taking of the second image 33. Preferably, much more actual displacement vectors IV_1 to IV_4 are determined.

In this context, one or more of the actual displacement vectors IV_1 to IV_4 can also be discarded after their determination, for example, when they show an angle which highly deviates from one or more averaged angles of the remaining actual displacement vectors IV_1 to IV_4. In this way, it is avoided that incorrectly determined actual displacement vectors IV_1 to IV_4 are taken into account in the further calculation.

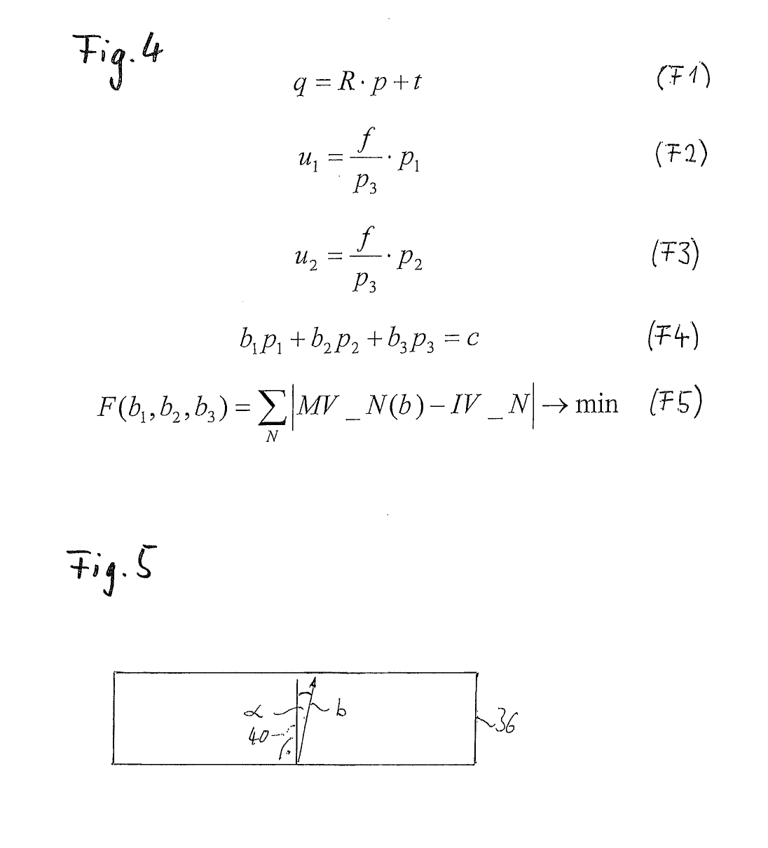

Starting out from the coordinates of the characteristic points 30 of the first image 32, model displacement vectors MV_N are determined based on the formulas F1 to F4 shown in FIG. 4 in addition to the actual displacement vectors IV_1 to IV_4. The determination of the model displacement vectors MV_N is merely briefly outlined in the following. For a detailed illustration, reference is made to the dissertation “Automatische Hinderniserkennung im fahrenden Kraftfahrzeug” [Automatic obstacle recognition in moving motor vehicle] by Dirk Feiden, Frankfort/Main, 2002 on pages 63 to 67 and to “Digital Video Processing” by Tekalp, A. M. Prentice Hall, 1995, the aforesaid pages 63-67 being incorporated herein by reference.

As a basic assumption it is assumed that the lane is planar, that the motor vehicle drives straight on and that the reference system moves with the motor vehicle. The formulas F2 and F3 show a relation between two-dimensional coordinates u1 and u2, of, for example, one characteristic point 30, in the image plane of the camera and corresponding three-dimensional coordinates p1, p2, p3, of, for example, the corresponding characteristic point 30 on the real lane. The formulas F2 and F3 are basically also referred to as imaging equations of a pinhole camera. On the basis of the imaging equations of the pinhole camera, thus, starting out from the characteristic points 30 detected in the first image 32, their three-dimensional coordinates can be determined in reality. Further, by way of the general equation of motion illustrated in formula F1 three-dimensional coordinates of a point q can be determined which corresponds to the coordinates of a point p after an arbitrary motion of the point p in the three-dimensional space. R designates a rotation matrix, and t designates a translation vector, which depend on a motion of the motor vehicle. If one assumes, simplified, that the motor vehicle drives straight forward and/or the calculation is only made when a yaw rate of the motor vehicle is equal to zero, then the rotation matrix R is simplified to become a unit matrix, and the translation vector has only one component which is not equal to zero and depends on the speed of the motor vehicle. Thus, the three-dimensional coordinates q1, q2, q3 of the characteristic points 30 can be determined after the motion of the motor vehicle between the taking of the first image 32 and the taking of the second image 33. In a fourth formula F4, the general equation of planes is illustrated which is met by all points of a plane, with b1 to b3 being the coordinates of the normal vector of the respective plane. By way of the general imaging equations of the pinhole camera and the general equation of planes, the model displacement vectors MV_N can now be determined depending on a model normal vector b, which model displacement vectors are representative for the displacement of the characteristic points 30 from the first to the second image 32, 33, however determined via the displacement of the characteristic points 30 in reality depending on the motion of the motor vehicle.

In other words, the displacement of the characteristic points 30 between the takings of the images 32, 33 is determined, on the one hand, by simple measurement in the image plane, which is represented by the actual displacement vectors IV_N, and, on the other hand, by determining the actual displacement of the characteristic points 30 on the real lane relative to the motor vehicle and transformed onto the image plane. Thus, the displacement of the characteristic points 30 as a result of the motion of the motor vehicle is determined in two different ways.

A function according to Formula F5 now represents the sum over the amounts of the differences of all model displacement vectors MV_N and actual displacement vectors IV_N. When this sum is minimal, then the model displacement vectors MV_N correspond particularly well to the actual displacement vectors. Further, the sum can be minimized by variation of the model normal vector b. Therefore, it is assumed that the model normal vector b corresponds to the actual normal vector on the lane, in particular the road 20, when the sum is minimal. In other words, the model displacement vectors MV_N are varied by variation of the model normal vector b until they correspond to the actual displacement vectors IV_N as accurately as possible. Preferably, so many displacement vectors are determined on the basis of the two or further images and via the illustrated model that the equation according to the Formula F5 I is highly overdetermined. This allows for a particularly precise approximation to the actual normal vector of the road plane.

FIG. 5 schematically shows a projection of the determined model normal vector b onto the screen plane. The projected model normal vector b encloses an angle, in particular the roll angle α, with an image normal 40 that is perpendicular to a lower image edge of the image plane 36. For compensating the roll angle α, this angle can now be taken into account in the image analysis system, and the image can be rotated accordingly. Preferably, however, the image is not modified but the determined angle of rotation α is provided to the driver assistance system and/or further vehicle systems so that these can directly take the roll angle α into account, in particular compensate it.

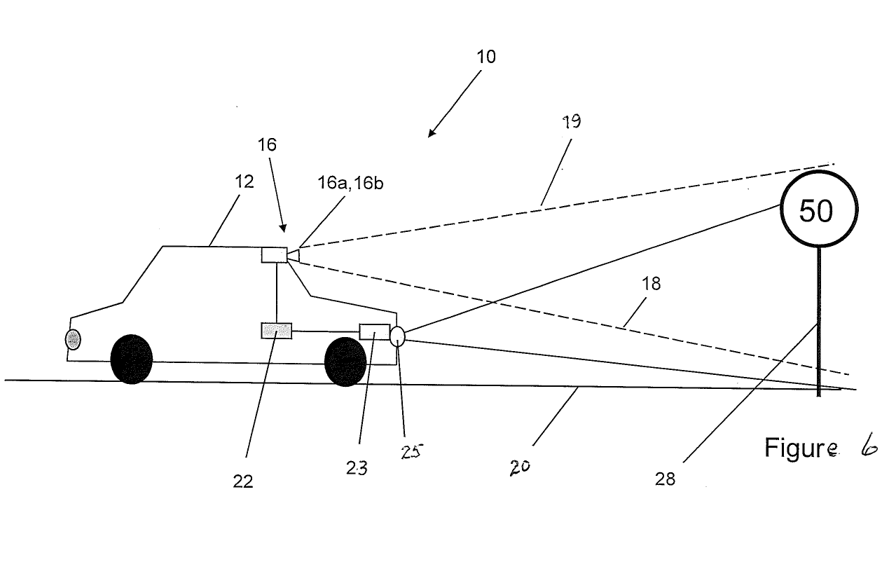

FIG. 6 shows a side view of a vehicle 12 in a traffic situation during driving of the vehicle 12 along the road 14. A stereo camera system 16 captures a sequence of images with images of a detection range in front of the vehicle 12. The horizontal detection range is illustrated schematically in FIG. 1 by the dashed lines 18, 19. By means of the left individual camera 16a and the right individual camera 16b of the stereo camera system 16 thus images with pictures of objects present in the detection range are captured and image data corresponding to the images are generated. The image data are transmitted from the stereo camera system 16 to a processing unit 22 arranged in the vehicle 12 and are further processed by the processing unit 22, in particular to provide a driver assistance system for the driver of the vehicle 12. To this end, by means of the stereo camera system 16 the objects present in detection range in front of the vehicle 12, such as the traffic sign 28 illustrated in FIG. 1 arranged laterally to the road 20, are captured. By means of the stereo camera system 16 additionally the distance of the stereo camera system 16 additionally the distance of the stereo camera system 16 with respect to the traffic sign 28 as well as the respect to other objects can be determined with high accuracy. To allow this high accuracy with respect to the distance measurement, the individual cameras 16a, 16b of the stereo camera system 16 have to be exactly adjusted with respect to each other. At least the relative position of the optical axes of the individual cameras 16a, 16b with respect to each other and/or with respect to a stereo camera- and/or vehicle coordinate system has to be known. Thus, the stereo camera system 16 has to calibrate exactly to the relative position of the optical axes of the individual cameras 16a, 16b.

The image data of the object 28 generated by the stereo camera system 16 are processed by the processing unit 22, wherein an electronic image of a traffic sign is stored for comparison and identification purposes. In the same manner further traffic signs, guide devices, street lightings, vehicles driving ahead on the road 20 and oncoming vehicles on an opposite lane of the road 20 can be detected as objects and the object type thereof can be found and identified.

For the detected objects object parameters can be respectively determined. Such object parameters can be an object class determined for the respective object, the three-dimensional position of the object, the three-dimensional moving direction of the object, the speed of the object and/or the duration of the observation of the object in an image sequence captured by means of the stereo camera system 16 of the vehicle 12. These object parameters can be used as input values for an evaluation procedure for the classification of the object by the processing unit 22. The classification result can in turn be used for the control of the light emission effected by means of at least one head light 25 of the vehicle 12 and light distribution by a light control module 23 activating the head light 25.

The respective position of the optical axes of the individual cameras 16a, 16b is generally referred to in relation to a vehicle axis system, as the already mentioned vehicle coordinate system or a camera coordinate system of the stereo camera system 16. Based on such a vehicle axis system also the position of the optical axes of the cameras 16a, 16b with respect to a world coordinate system can be determined. The mentioned vehicle coordinate system is a rectangular coordinate system with an origin preferably in the centre of the vehicle 12, such that the x-axis is directed ahead and preferably horizontal and is located in the longitudinal middle plane of the vehicle. The y-axis stands perpendicular on the longitudinal middle plane of the vehicle and points to the left. The z-axis points above.

The precise adjustment of the left individual camera 16a and the right individual camera 16b of the stereo camera system 16 is influenced by a plurality of environmental influences, e.g. by vibration during driving of the vehicle 12 or by aging processes, that is why a recalibration of the stereo camera system 16 also during driving of the vehicle 12 may be necessary.

The aberrations of the actual adjustment of the optical axes of the individual cameras 16a, 16b relative to each other with respect to their correct relative adjustment consist essentially of three possible angle errors, the yaw angle error, the wankel angle error and the pitch angle error. With respect to a camera coordinate system, which has the same adjustment as the vehicle coordinate system, apart from the origin of the optical axis of the camera being inside the camera, the yaw angle of a camera is an angle resulting from the rotation about the z-axis. The wankel angle of a camera is an angle resulting from a rotation about the x-axis and the pitch angle of a camera is an angle resulting from a rotation about the y-axis.

What is claimed is:

1. A method for compensating a roll angle (α) when operating a camera-based driver assistance system in a motor vehicle, in which:
with the aid of a camera, a first image (32) is taken and the coordinates of at least two characteristic points (30) of the first image (32) are determined;
with the aid of the camera, a second image (33) is taken and the coordinates of the two characteristic points (30) in the second image (33) are determined;
depending on the determined coordinates of the characteristic points (30) in the first and the second image (32, 33) two actual displacement vectors (IV_1, IV_3) are determined, each of which is representative for a displacement of the characteristic points from the first image (32) to the second image (33) in an image plane of the camera;
depending on the determined coordinates of the characteristic points (30) of the first image (32) and depending on a motion of the motor vehicle between the taking of the first and of the second image (32, 33) two model displacement vectors (MV_N) are determined, each of which models the displacement of the characteristic points (30) from the first image (32) to the second image (33) in the image plane;
depending on the determined actual displacement vectors (IV_1, IV_3) and model displacement vectors (MV_N) a reference vector is determined,
depending on the determined reference vector the roll angle (a) is determined.

2. The method according to claim 1, in which the reference vector is a model normal vector (b) which is perpendicular to a plane in which the characteristic points (30) actually lie.

3. The method according to claim 2, in which the roll angle (a) is determined by projecting the model normal vector (b) onto the image plane and by comparing the projected model normal vector (b) with an image normal (40) of the camera.

4. The method according to claim 3, in which the roll angle (a) corresponds to the angle between the projected model normal vector (b) and the image normal (40).

5. The method according to claim 1, in which with respect to every determined actual displacement vector (IV_N) one model displacement vector (MV_N) is determined.

6. The method according to claim 1, in which three or more actual displacement vectors (IV_1, IV_2, IV_3, IV_4) and accordingly three or more model displacement vectors (MV_N) are determined, depending on which then the model normal vector (b) is determined.

7. The method according to claim 6, in which at least one displacement vector (IV_1, IV_2, IV_3, IV_4) whose angular deviation from one or more averaged vectors is the largest is discarded and no longer taken into account.

8. The method according to claim 1, in which the model displacement vectors (MV_N) are dependent on the coordinates of the model normal vector (b), and the model normal vector (b) is determined in that by varying the coordinates of the model normal vector (b) a function value of a function (F5) is minimized which corresponds to a difference between all actual displacement vectors (IV_1, IV_2, IV_3, IV_4) taken into account and the corresponding model displacement vectors (MV_N).

9. The method according to claim 1, in which the determined roll angle (a) is used for image correction of the camera image and/or is automatically provided to the driver assistance system.

10. The method according to claim 1, in which the model displacement vectors (MV_N) are determined by means of the general equation of motion, the imaging equation of a pinhole camera and the general equation of planes.

11. A system including a camera and processing unit mounted on a vehicle wherein the processing unit is programmed to execute the method according to claim 1.
